(19) United States
(12) Patent Application Publication
(10) Pub. No.: US 2023/0118469 A1
(43) Pub. Date: Apr. 20, 2023

(54) Method and System for Producing Recycled Fibers for MDF or HDF Production

(71) Applicant: Valmet Technologies Oy, Espoo (FI)

(72) Inventor: Robert Mohr, Floersheim (DE)

(73) Assignee: Valmet Technologies Oy, Espoo (FI)

(21) Appl. No.: 17/911,999

(22) PCT Filed: May 7, 2021
(86) PCT No.: PCT/FI2021/050338

§ 371 Date: Sep. 15, 2022

(30) Foreign Application Priority Data
May 13, 2020 (SE) 2050556-6

(51) Int. Cl. D21H 11/14; D21C 3/22; D21C 9/18; D21D 5/02

(52) U.S. Cl. CPC D21H 11/14; D21C 3/224; D21C 9/18; D21D 5/02

(57) ABSTRACT

Recycled fibers are produced from MDF or HDF containing material, for instance for use in MDF or HDF production by steaming (2) the MDF or HDF containing material for a predetermined time to obtain steamed material, subjecting the steamed material to a pulping process (3) to obtain a slurry, screening (4a, 4b) the slurry to remove oversize particles to obtain a screened slurry, dewatering (5) the screened slurry to obtain dewatered fibers and refining or fluffing (6) the dewatered fibers to obtain said recycled fibers. A method for producing MDF or HDF boards using such recycled fibers is also provided. Corresponding systems for producing recycled fibers and producing MDF or HDF boards are also provided.

### CROSS REFERENCES TO RELATED APPLICATIONS

This application is a U.S. National Stage application based on PCT/FI2021/050338 filed on May 7, 2021, and claims priority on Swedish App. No. 2050556-6, filed on May 13, 2020, the disclosures of which are incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The invention relates to a method and a system for producing recycled fibers from MDF or HDF containing material.

Large scale production of Medium Density Fiberboard (MDF) began in the 1980's. High Density Fiberboard (HDF) is a similar product, although with a density which is usually higher than MDF. MDF/HDF is used in various applications such as furniture and flooring. Today, many tons of used MDF/HDF containing objects are thrown away every year and thereafter burned since methods for recycling such objects are not known.

### SUMMARY OF THE INVENTION

An object of the invention is to provide a method and system for recycling MDF or HDF containing material in order to produce fibers suitable for production of new MDF/HDF.

According to a first aspect of the invention, there is provided a method for producing recycled fibers from MDF or HDF containing material, for instance for use in MDF or HDF production or for use as strengthening fibers in containerboard. The method comprises steaming the MDF or HDF containing material for a predetermined time to obtain steamed material, subjecting the steamed material to a pulping process to obtain a slurry, screening the slurry to remove oversize particles to obtain a screened slurry, dewatering the screened slurry to obtain dewatered fibers and refining or fluffing the dewatered fibers to obtain said recycled fibers.

It is understood that the MDF or HDF containing material refers to objects which at least partly consist of MDF or HDF, such as pieces or chips of recycled furniture, recycled flooring or raw board reject, i.e. pieces of MDF or HDF board which is rejected in an MDF or HDF sheet forming line. It is furthermore understood that the term oversize particles includes, but is not limited to, non-fibrous material such as plastic, paper, metal or the like which are part of the raw material (MDF or HDF containing material), also including wood pieces coming from other types of panelboards as well as waterproof glued pieces of MDF and HDF.

The method according to the first aspect of the invention is normally carried out continuously together with an MDF or HDF sheet forming line, supplying recycled fibers thereto. It is however possible to carry out the method batch-wise and supply recycled fibers to an MDF or HDF sheet forming line at a later time.

The invention is based on the insight that recycled fibers suitable for MDF or HDF production can be surprisingly effectively released from MDF or HDF containing material, in particular recycled material, by steaming and pulping the material. The invention is furthermore based on the insight that such steaming and pulping leaves non-desirable particles such as plastic, paper or metal largely unaffected size-wise which allows these oversize particles to be removed by means of screening.

In the embodiments, the MDF or HDF containing material is provided in the form of chips having an area of less than 10,000 mm², preferably less than 3600 mm². The chips typically have a thickness which is substantially less than their length, but may be from 1.5 mm up to 60 mm.

In the embodiments, the method further comprises providing the MDF or HDF containing material by means of reducing the size of an MDF or HDF containing object, for instance into chips.

In the embodiments, the predetermined time is 1-30 min, preferably 5-20 min. The steaming may be carried out using steam having a temperature in the range of 95-105° C. The steaming is normally carried out at atmospheric pressure, i.e., with 100° C. steam, but it is understood that the steam could be slightly cooled off before reaching the MDF or HDF containing material. The steaming may alternatively be performed at slightly above 100° C. (i.e., at slight overpressure). Considering that MDF or HDF containing material from recycled furniture or flooring often comprises plastic, it is not suitable to use an excessively high steam temperature (much above 100° C.). The steaming is preferably carried out at 90% consistency or more.

The steaming referred to above can be done as pre-steaming before pulping apparatus or by introducing steam or hot water directly to the pulping apparatus at the pulping consistency.

In the embodiments, the pulping process is performed at 60-95° C. The pulping process may be performed at a consistency of 2-8%, preferably about 4%.

In embodiments, the screening comprises using a coarse screen and/or a fine screen, wherein the coarse screen has larger perforations than the fine screen. Coarse screening and/or fine screening may comprise more than one screen and/or screening stages. The coarse screen/-s may have holes having a diameter of 2-5 mm. The fine screen/-s may have slots having a width of 0.2-0.9 mm or holes having a diameter of 1-4 mm.

Before the screening stages there can be a high consistency cleaner to remove heavy particles.

In the embodiments, the dewatering is carried out to a consistency of at least 30%, preferably around 50%.

In the embodiments, the refining comprises using a refiner, preferably a disc or a conical refiner having a fillings gap of 2-8 mm, preferably 3-5 mm, such as 4 mm. In other embodiments, the fluffing comprises using a fluffer having a gap of 2-8 mm, preferably 3-5 mm, such as 4 mm.

According to a second aspect of the invention there is provided a method for producing MDF or HDF boards comprising producing recycled fibers using the method according to the first aspect of the invention or embodiments thereof, coating the recycled fibers with at least one binding agent, drying the coated recycled fibers, and after said drying, forming MDF or HDF sheets using the dried fibers, or in other words feeding the fibers to an MDF or HDF forming line. It is understood that coating the fibers with at least one binding agent refers to applying a glue or adhesion or binding agent to the fibers to allow the fibers to adhere or bind to each other further downstream in the process.

In the embodiments of the method according to the second aspect of the invention, the method further comprises providing new biomass fibers from biomass material, coating the new biomass fibers with a binding agent, drying the coated new biomass fibers and mixing the new biomass fibers with the recycled fibers before said coating, or after said coating, or after said drying, such that new biomass fibers and recycled fibers are both fed to said MDF or HDF sheet forming line. In other words, the MDF/HDF production is based on recycled and new fibers. The method normally comprises producing the new biomass fibers from biomass such as tree material, bagasse, straw or any other type of biomass suitable to be used as the basis for MDF/HDF production. Such process steps are well known in the art and will not be described in further detail here. Alternatively, the new fibers may be provided from another location and/or from a previous batch. As described above, the new biomass fibers are mixed with the recycled fibers before said coating, or after said coating, or after said drying. In other words, it is foreseeable that the new and recycled fibers are coated together (mixing before/during the coating) or that the fibers are dried together (mixing after said coating or during drying) or pre-treated separately (mixing after drying). In other embodiments, the MDF/HDF production is based solely on recycled fibers.

In embodiments of the method according to the second aspect of the invention, the coating is carried out using a blowline, in which said at least one binding agent is injected/sprayed.

According to a third aspect of the invention there is provided a system for producing recycled fibers from recycled MDF or HDF material, for instance for use in MDF or HDF production or for use as strengthening fibers in containerboard. The system comprises a steaming apparatus provided with an inlet for said MDF or HDF containing material and at least one steam inlet connected to a source of steam to provide steam to said material, a pulping apparatus connected to an outlet of said steaming apparatus and being configured to subject the steamed material to a pulping process to provide a slurry, a screening system connected to an outlet of said pulping apparatus and being configured to remove oversize particles from said slurry, a dewatering apparatus connected to an outlet of said screening system and being configured to dewater the slurry, and a refiner or fluffer connected to an outlet of said dewatering apparatus and being configured to refine the dewatered slurry to produce said recycled fibers.

In embodiments of the system according to the third aspect of the invention, the steaming apparatus is an atmospheric steamer using low pressure steam or steaming to the pulping apparatus is at low steaming pressure. The screening system may comprise a coarse screen and/or a fine screen/-s, wherein the coarse screen has larger perforations than the fine screens.

Such a screening system is known in the art and will not be described in further detail here. The dewatering apparatus may be a twin-roll press, a screw press, a twin-wire press, or any other suitable apparatus known to the person skilled in the art. The refiner/fluffer may be of the atmospheric/open type and may furthermore be of the low or high consistency type. The refiner may be a disc or a conical refiner.

According to a fourth aspect of the invention there is provided a system for producing MDF or HDF boards. The system comprises a system for producing recycled fibers according to the third aspect of the invention, coating means configured to coat the recycled fibers with at least one binding agent, drying means configured to dry the coated recycled fibers, and an MDF or HDF sheet forming line connected to the drying means to receive dried coated recycled fibers.

The features of the embodiments described above are combinable in any practically realizable way to form embodiments having combinations of these features. Further, all features and advantages of embodiments described above with reference to the first, second, third or fourth aspects of the invention may be applied in corresponding embodiments of any of the other aspects of the invention.

### BRIEF DESCRIPTION OF THE DRAWINGS

Above discussed and other aspects of the present invention will now be described in more detail using the appended drawings, which show presently preferred embodiments of the invention.

FIGS. 1A-1B show flowcharts of embodiments of the method according to the first aspect of the invention.

FIG. 2 shows a flowchart of an embodiment of the method according to the second aspect of the invention.

FIG. 3 shows a schematic illustration of an embodiment of a system according to the third aspect of the invention.

FIG. 4 shows a schematic illustration of an embodiment of a system according to the fourth aspect of the invention.

### DESCRIPTION OF THE PREFERRED EMBODIMENTS

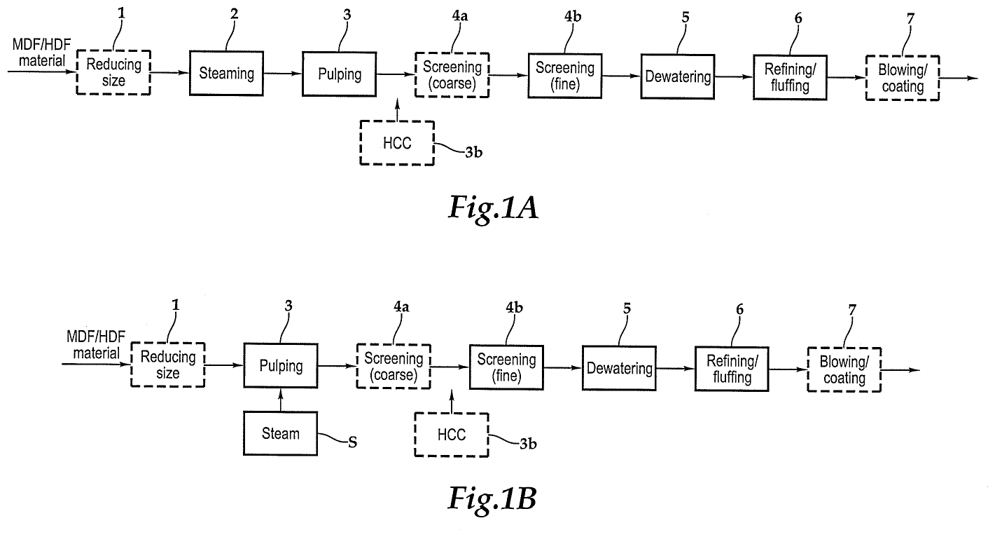

FIG. 1A shows a flowchart of an embodiment of the method according to the first aspect of the invention. The method comprises reducing 1 the size of one or more provided MDF or HDF containing objects into chips having an area of less than 10,000 mm², preferably less than 3,600 mm², for instance 40×40 mm, and having a thickness substantially less than their length/width. The reducing step is optional, since the MDF/HDF containing object may alternatively have been reduced in size to chips beforehand, such that pre-produced chips are provided to the steaming 2. The chips are steamed 2 for a predetermined time, preferably 5-20 minutes, preferably at atmospheric conditions with 100° C. steam, to obtain steamed material. The steaming can be done as pre-steaming before the pulping process in the pulping apparatus or by introducing steam or hot water directly to the pulping process in the pulping apparatus at the pulping consistency. The steaming is preferably carried out at 90% consistency or more. The steamed material is thereafter subjected to a pulping process 3, preferably at a temperature of 60-90° C. and at a consistency of about 4%, to obtain a slurry. The slurry is thereafter screened using a fine screening system 4b, optionally with a preceding coarse screening 4a, to remove oversize and undesired particles. The screened slurry is thereafter dewatered 5 to a consistency of at least 30%, preferably around 50%. The dewatered material is refined/fluffed 6 to obtain recycled fibers. The recycled fibers may optionally be coated 7 with at least one binding agent as part of the method. Between the pulping process 3 and the screening system 4a, 4b optionally a high consistency cleaning (HCC) stage 3b in a high consistency cleaning (HCC) device 3b can be located.

FIG. 1B is a flowchart of an embodiment of the method according to the first aspect of the invention and corresponds to the embodiment of the method as above referring to FIG. 1A but the steaming 2 has been omitted and the steaming is done by introducing steam S or hot water from a steam or hot water source S directly to the pulping process 3 in the pulping apparatus at the pulping consistency. The method comprises reducing 1 the size of one or more provided MDF or HDF containing objects into chips having an area of less than 10,000 mm², preferably less than 3,600 mm², for instance 40×40 mm, and having a thickness substantially less than their length/width. The reducing step is optional, since the MDF/HDF containing object may alternatively have been reduced in size to chips beforehand, such that pre-produced chips are provided. The steaming is done by introducing steam S or hot water from a steam or hot water source S directly to the pulping process 3 in the pulping apparatus at the pulping consistency. The material is subjected to a pulping process 3, preferably at a temperature of 60-90° C. and at a consistency of about 4%, to obtain a slurry. The slurry is thereafter screened using a fine screening system 4b, optionally with a preceding coarse screening 4a, to remove oversize and undesired particles. The screened slurry is thereafter dewatered 5 to a consistency of at least 30%, preferably around 50%. The dewatered material is refined/fluffed 6 to obtain recycled fibers. The recycled fibers may optionally be coated 7 with at least one binding agent as part of the method. Between the pulping process 3 and the screening system 4a, 4b optionally a high consistency cleaning (HCC) stage 3b in a high consistency cleaning (HCC) device 3b can be located.

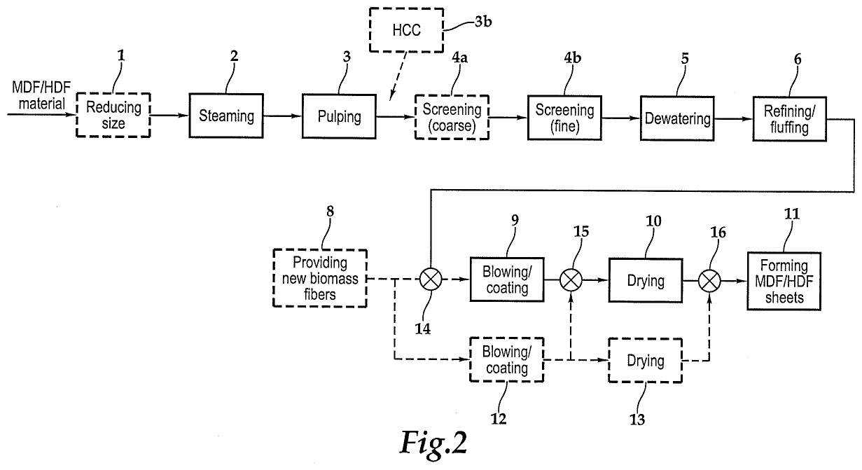

FIG. 2 shows a flowchart of an embodiment of the method according to the second aspect of the invention. The method comprises the same method steps 1-6 as shown in FIG. 1 and explained above. The method further comprises a coating step 9, which is similar to the coating 7 in FIG. 1 in that at least one binding agent such as resin and wax is added, except that new biomass fibers may be provided 8 and optionally be mixed 14 with the recycled fibers. The new biomass fibers may be produced from biomass such as tree material, bagasse, straw or any other type of biomass suitable to be used as basis for MDF/HDF production. The process steps involved in producing the new biomass fibers are well known to the person skilled in the art and will not be described in further detail herein. The coated fibers are thereafter dried 10, and after said drying, fed to an MDF or HDF sheet forming line 11. As indicated by the dotted arrows in the figure, the new biomass fibers may alternatively be subjected to a separate coating step 12 and be mixed 15 with the recycled fibers after coating 9 or may be subjected to separate coating and drying steps 12, 13, and be mixed 16 with the recycled fibers after the drying step 10. The process steps involved in MDF or HDF sheet forming are well known to the person skilled in the art and will not be described in further detail here.

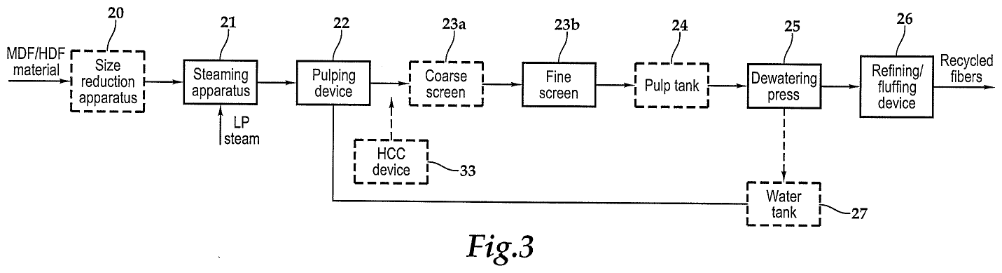

FIG. 3 shows a schematic illustration of an embodiment of a system according to the third aspect of the invention. The system comprises an optional size reduction apparatus 20, for instance a hammermill, and a steaming apparatus 21 being an atmospheric steamer provided with an inlet for said MDF or HDF containing material and at least one steam inlet connected to a source of low-pressure steam to provide steam to said material. A pulping apparatus 22 is connected to an outlet of the steaming apparatus 21 and is configured to subject the steamed material to a pulping process to provide a slurry. An optional coarse screening system 23a is connected to an outlet of the pulping apparatus 22 and is configured to remove oversize particles from the slurry. A fine screening system 23b is connected to an outlet of the coarse screening system 23a or (in embodiments without a coarse screen) to the pulping apparatus 22 and is configured to remove smaller particles from the slurry. The coarse screen has holes with a diameter of 2-5 mm. The fine screen has slots having a width of 0.2-0.9 mm or holes having a diameter of 1-4 mm. The outlet of the fine screening system is connected to an optional pulp tank 24 in which the slurry may be stored prior to being fed to a dewatering apparatus 25, which is a screw press or similar. The water pressed out from the dewatering apparatus may be fed to an optional water tank 27 from which it is recycled for use in the pulping apparatus. An atmospheric refiner 26 is connected to an outlet of the dewatering apparatus 25 and is configured to refine the dewatered slurry to produce said recycled fibers. The refiner has a fillings gap of 3-5 mm, preferably about 4 mm. Between the pulping apparatus 22 and the screening system 23a, 23b optionally a high consistency cleaning (HCC) stage 3b in a high consistency cleaning (HCC) device 33 can be located.

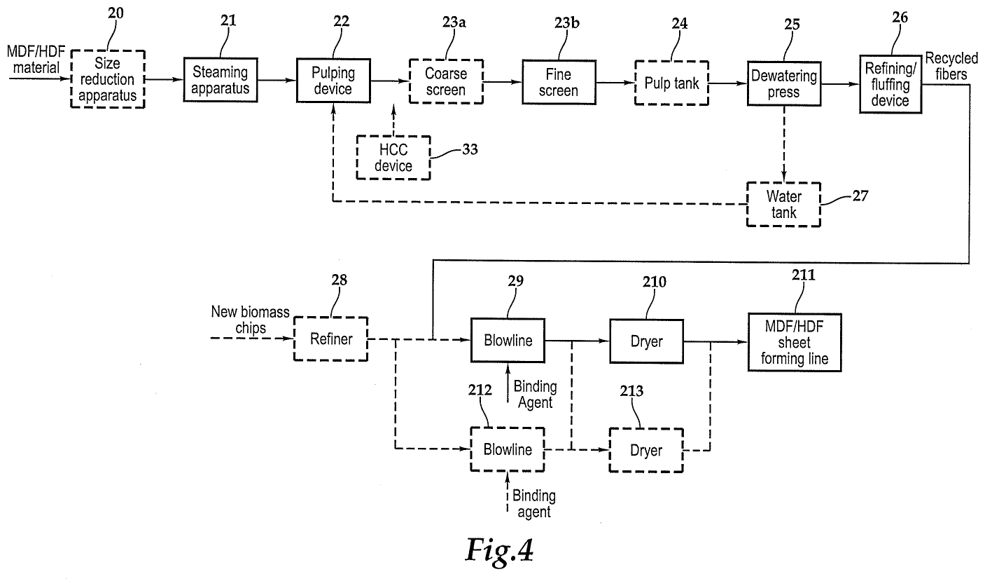

FIG. 4 shows a schematic illustration of an embodiment of a system according to the fourth aspect of the invention. The system comprises the same devices and screening systems 20-27 as shown in FIG. 3 and described above. The outlet of the refiner 26 is connected to a blowline 29, in which at least one binding agent is injected/sprayed to coat the recycled fibers while being conveyed to a dryer 210, being of a conventional type as used in MDF/HDF production lines. The outlet of the dryer 210 is connected to an MDF or HDF sheet forming line 211. Optionally, new biomass fibers may be provided such that the MDF or HDF sheets are formed from a combination of new and recycled fibers. In FIG. 4, new biomass fibers are illustrated as being provided in the form of new biomass chips which are fed to a refiner/defibrator 28 for size reduction/refining. In other embodiments, the system may furthermore comprise devices such as a debarker, chipper, screen and chip washer involved in the production of producing the biomass chips fed to the refiner 28. In yet other embodiments, the refiner 28 is omitted, and new biomass fibers are supplied directly, for instance from a tank containing previously produced fibers. As illustrated in the figure, the new fibers may be added together with the recycled fibers to an inlet of the blowline 29 such that the new and recycled fibers are coated/blown and dried together. Alternatively, the new biomass fibers may be fed to a separate (optional) blowline 212 and be fed together with the recycled fibers to the dryer 210 or may be fed to a separate (optional) dryer 213 and be mixed with the recycled fibers after drying by being fed together to the MDF or HDF sheet forming line 211. The devices and screening systems comprised in an MDF or HDF sheet forming line 211 are well known to the person skilled in the art and will not be described in further detail here.

The description above and the appended drawings are to be considered as non-limiting examples of the invention. The person skilled in the art realizes that several changes and modifications may be made within the scope of the invention.

For example, the MDF or HDF containing material does not necessarily need to be furniture, flooring or raw board reject, but may be any type of object or material comprising MDF or HDF. Furthermore, the MDF or HDF containing material does not necessarily need to be provided as chips in the literal sense thereof but may have any form or size as long as said form or size allows the steam to effectively treat the material. Furthermore, the described residence times, temperatures and consistencies are only exemplary, and may need to be varied outside the proposed ranges depending on the content and size of the provided raw material.

1-21. (canceled)

22. A method for producing recycled fibers from MDF or HDF containing material comprising the steps of:
receiving MDF or HDF containing material;
steaming the received MDF or HDF containing material for a predetermined time to obtain treated material;
subjecting the treated material to a pulping process to obtain a slurry;
screening the slurry to remove oversize particles to obtain a screened slurry;
dewatering the screened slurry to obtain dewatered fibers; and
refining or fluffing the dewatered fibers to obtain recycled fibers.

23. The method of claim 22 wherein the MDF or HDF containing material is provided in the form of chips having an area of less than 10,000 mm2.

24. The method of claim 22 further comprising the step of providing the MDF or HDF containing material by reducing the size of an MDF or HDF containing object into chips.

25. The method of claim 22 wherein the step of steaming the MDF or HDF containing material with water or steam is done as pre-steaming before the pulping process or by introducing steam or hot water directly to the pulping process.

26. The method of claim 22 wherein the step of steaming the MDF or HDF containing material is carried out by introducing steam or hot water having a temperature between 60 and 105° C. for 5-20 min.

27. The method of claim 22 wherein the predetermined time is 5-20 minutes.

28. The method of claim 22 where the step of steaming the MDF or HDF containing material is carried out with water or steam having a temperature between 95-105° C.

29. The method of claim 22 where the step of steaming the MDF or HDF containing material is carried out with steam of at least 90% consistency.

30. The method of claim 22 where the step of subjecting the treated MDF or HDF containing material to the pulping process is carried out at 60-90° C.

31. The method of claim 22 where the step of subjecting the treated MDF or HDF containing material to the pulping process is performed at a consistency of 2-8%.

32. The method of claim 22 wherein the step of screening the slurry to remove oversize particles further comprises:
using a coarse screen to remove oversize particles from the slurry; and
using a fine screen to remove smaller particles from the slurry, wherein the coarse screen has larger perforations than the fine screen.

33. The method of claim 22 wherein the step of dewatering the screened slurry to obtain dewatered fibers is carried out to a consistency of at least 30%.

34. The method of claim 22 wherein the step of dewatering the screened slurry to obtain dewatered fibers is carried out to a consistency of about 50%.

35. The method of claim 22 wherein the step of refining or fluffing the dewatered fibers comprises using a refiner having a fillings gap of 2-8 mm.

36. The method of claim 22 wherein the step of refining or fluffing the dewatered fibers to obtain said recycled fibers, comprises using a fluffer having a gap of 3-5 mm.

37. The method of claim 22 further comprising:
coating the recycled fibers with at least one binding agent;
drying the coated recycled fibers; and
forming MDF or HDF sheets using the dried fibers.

38. The method of claim 37 further comprising:
providing new biomass fibers from biomass material;
coating the new biomass fibers with a binding agent;
drying the coated new biomass fibers; and
mixing the coated new biomass fibers with the recycled fibers before the coating step, or after the coating step, or after the drying step, such that the coated new biomass fibers and recycled fibers are both fed to the step of forming MDF or HDF sheets.

39. The method of claim 38 wherein the step of coating the recycled fibers with a binding agent is carried out using a blowline, in which said binding agent is injected.

40. A system for producing recycled fibers from recycled MDF or HDF material, said system comprising:
a source of MDF or HDF containing material;
a steaming apparatus provided with an inlet for receiving MDF or HDF containing material from the source of MDF or HDF containing material, and at least one steam inlet connected to a source of steam;
a pulping apparatus connected to an outlet of said steaming apparatus and being configured to subject the steamed material to a pulping process to provide a slurry;
a screening system connected to an outlet of the pulping apparatus and being configured to remove oversize particles from the slurry;
a dewatering apparatus connected to an outlet of the screening system and being configured to dewater the slurry, and
a refiner or fluffer connected to an outlet of said dewatering apparatus and being configured to refine the dewatered slurry to produce recycled fibers.

41. The system of claim 40 further comprising:
a coating apparatus configured to coat the recycled fibers with at least one binding agent;
a dryer configured to dry the coated recycled fibers, and
an MDF or HDF sheet forming line connected to the dryer and being configured to produce MDF or HDF sheets using dried coated recycled fibers.

42. A system for producing recycled fibers from recycled MDF or HDF material, said system comprising:
a source of MDF or HDF containing material;
a pre-steaming device connected to receive MDF or HDF containing material from the source of MDF or HDF containing material, and subject it to steaming;
a pulping apparatus connected to an outlet of the pre-steaming device and being configured to subject the steamed material to a pulping process to provide a slurry;
a screening system connected to an outlet of said pulping apparatus and being configured to remove oversize particles from said slurry;
a dewatering apparatus connected to an outlet of said screening system and being configured to dewater the slurry; and
a refiner or fluffer connected to an outlet of said dewatering apparatus and being configured to refine the dewatered slurry to produce said recycled fibers.
